(19) United States
(12) Patent Application Publication
(10) Pub. No.: US 2026/0189013 A1
(43) Pub. Date: Jul. 2, 2026

(54) DISTRIBUTED ENERGY RESOURCE CONTROL

(71) Applicant: FORD GLOBAL TECHNOLOGIES, LLC, Dearborn, MI (US)

(72) Inventors: Haider Mhiesan, Canton, MI (US); Timothy Harris, Grosse Ile, MI (US); Kirk Pulay, Belleville, MI (US); Christopher Bernard Trombetta, Commerce Township, MI (US)

(21) Appl. No.: 19/303,485

(22) Filed: Aug. 19, 2025

Related U.S. Application Data
(60) Provisional application No. 63/739,980, filed on Dec. 30, 2024.

(51) Int. Cl. H02J 3/38; H02J 9/06

(52) U.S. Cl. CPC H02J 3/381; H02J 9/062

(57) ABSTRACT

A home energy management system (HEMS) includes a controller configured to monitor an electrical parameter on a line coupled to a distributed energy resource (DER), and an inverter electrically connected to the line and operable to generate an alternating current (AC) voltage on the line. The controller is configured to, after a DER shutdown trigger, and the DER producing an output after an interval, command the inverter to increase the AC voltage on the line to a level that induces a shutdown response from the DER.

### CROSS-REFERENCE TO RELATED APPLICATION

This application claims the benefit of U.S. provisional application Ser. No. 63/739,980 filed Dec. 30, 2024, the disclosure of which is hereby incorporated in its entirety by reference herein.

### TECHNICAL FIELD

This disclosure relates to power management.

### BACKGROUND

A local energy source may provide electrical power to a building or connected loads independently of utility grid availability.

### SUMMARY

A home energy management system (HEMS) includes a controller configured to monitor an electrical parameter on a line coupled to a distributed energy resource (DER), and an inverter electrically connected to the line and operable to generate an alternating current (AC) voltage on the line. The controller is configured to, after a DER shutdown trigger, and the DER producing an output after an interval, command the inverter to increase the AC voltage on the line to a level that induces a shutdown response from the DER.

A home energy system includes a distributed energy resource (DER) configured to output electrical power for an alternating current (AC) line. The DER is further configured to cease outputting the electrical power when a voltage on the AC line exceeds a value. The home energy system further includes an inverter electrically connected to the AC line and operable to generate an AC voltage on the AC line, and a controller operatively coupled to the inverter. The controller is configured to command the inverter to increase the AC voltage on the AC line such that the distributed energy resource ceases the outputting.

A method of operating a home energy system includes, in response to a distributed energy resource (DER) not discontinuing a power output to an AC line within an interval beginning with a condition under which the DER is expected to discontinue the power output, increasing, by an inverter electrically coupled to the AC line, a voltage on the AC line.

### BRIEF DESCRIPTION OF THE DRAWINGS

FIG. 1 is a schematic diagram of a home energy system including a distributed energy resource.

FIG. 2 depicts an algorithm for identifying a misbehaving power source and enforcing a shutdown response using voltage manipulation.

FIG. 3 depicts energy metrics over time during a representative operating sequence.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A home energy system may include a variety of energy-related components that operate together to supply electrical power to a residence. These components may include a utility grid connection, one or more locally installed power sources such as photovoltaic (PV) panels, a generator, a stationary battery, or a vehicle energy source, and one or more load centers or service panels that distribute power to appliances, lighting circuits, and other domestic loads. The system may further include power converters, relays, measurement circuits, and energy management components to coordinate the exchange of electrical energy between sources and loads. In some implementations, the system includes an electric vehicle (EV) and associated electric vehicle supply equipment (EVSE), allowing a traction battery of the EV to be charged from home energy sources or to supply energy to the home in a bidirectional configuration.

To facilitate intelligent coordination of these components, the system may include a Home Energy Management System (HEMS). The HEMS may operate as a centralized or distributed controller that monitors grid status, power flows, system voltage, and device activity to manage energy usage and availability. In addition to supporting normal operation, the HEMS may execute programmed responses to abnormal conditions such as grid outages or faults. These responses may include isolating loads, activating standby power sources, or initiating shutdown procedures for specific devices.

In some implementations, discussed in greater detail herein, the HEMS may be configured to generate voltage conditions intended to influence the operation of attached energy devices. For example, the HEMS may issue a temporary voltage rise on one or more connected lines to prompt a shutdown response from selected power sources. This approach allows the HEMS to coordinate behavior among distributed power contributors, particularly during conditions in which the grid is unavailable and local management of energy flows becomes increasingly important.

During grid-connected operation, electrical energy may be delivered to the home from a utility power source via an incoming service line. This energy may be routed through a main service panel or other distribution equipment to power various household loads. Local energy sources—such as solar photovoltaic systems, a generator, or a bidirectionally capable vehicle energy system—may also be connected within the home energy system. These sources may contribute energy to the home or export energy back to the grid, depending on system configuration and operating conditions. In many implementations, these sources are configured to operate in parallel with the grid and may synchronize to grid voltage and frequency when active. A supervisory control component, such as a home energy management system, may monitor grid status, energy consumption, and the availability of local sources in order to determine how best to utilize available energy. Under normal conditions, the control system may prioritize the use of grid power while selectively engaging local sources based on demand, pricing signals, or other control criteria. Components designed to operate during outage or backup scenarios may remain unpowered or in standby during this grid-connected mode.

When the utility grid becomes unavailable, the home energy system may enter a grid-loss or off-grid operating mode. In this state, grid-synchronized devices may cease operation, and the system may rely on local energy sources to maintain functionality. Depending on the implementation, the control system may detect the loss of grid voltage and initiate logic configured to assess which local sources are capable of continuing to provide power under off-grid conditions. Some sources, such as traditional grid-following photovoltaic inverters, may disconnect automatically in response to grid loss, while others—such as standby generators or appropriately configured energy storage systems—may continue to operate or may be activated by the control system. During grid-loss conditions, certain subsystems that remain inactive during grid-connected operation may become active to support autonomous operation and facilitate coordination of remaining energy assets.

Distributed energy resources (DERs) may be integrated into a home energy system to locally generate or store electrical energy for use by a residence. As used herein, the term “DER” refers to an on-site or nearby energy source or storage system capable of supplying electrical power to the home. DERs may include photovoltaic (PV) systems that convert solar energy into electrical power, combustion-powered generators configured to produce alternating current (AC) output, stationary batteries that store and discharge energy through power electronic interfaces, and electric vehicles (EVs) equipped with vehicle-to-home (V2H) functionality that enables a traction battery to supply energy back to the home. These DERs may vary in their operating characteristics, such as whether they require synchronization with grid voltage or can operate independently, and whether they interface using direct current (DC) or AC connections.

One or more DERs may be connected to the home via an electric service panel, a home energy gateway, or a local load center. In certain implementations, each DER may be associated with one or more power electronics components—such as inverters, relays, and metering circuits—that condition its electrical output and control its connection to other system components.

While the characteristics of each DER may differ depending on its physical makeup and electrical design, these distributed energy contributors generally share the ability to provide at least some level of localized power to support residential loads. In certain embodiments, a DER may be configured to export power to the electric grid or to charge a vehicle or storage system. In other embodiments, a DER may be used primarily for backup power and remain inactive until a loss of grid connectivity is detected. Depending on the system architecture, a home may include a combination of active and standby DERs, with an energy management interface or supervisory logic coordinating their operation based on real-time needs.

The HEMS may be configured to monitor and coordinate the operation of DERs installed within the home energy system. These distributed energy sources can dynamically vary in availability and operational behavior depending on environmental conditions, load demands, and system state. The HEMS may identify which of these sources are active, idle, or in standby, and may selectively permit or restrict their contribution to the overall energy ecosystem based on system conditions. For example, when grid power is present, the HEMS may prioritize the use of grid energy and permit DERs to operate in parallel or remain offline; when grid power is lost, the HEMS may activate backup-capable DERs and initiate shutoff protocols for others.

To implement such coordination, the HEMS may track electrical parameters associated with each DER, such as output voltage, current, power factor, or frequency. In some examples, the HEMS may use predefined profiles to identify whether a DER operates in a grid-following or grid-forming mode, and tailor control actions accordingly. The HEMS may activate DERs in a staged or prioritized manner, delay or sequence their output, or issue operating commands through local control interfaces or networked communications.

Distributed energy sources within a home energy system may be broadly categorized based on their operating behavior with respect to an external grid reference. In many implementations, a DER is configured to operate in a grid-following mode, wherein the source synchronizes its output voltage and frequency to a grid signal or external reference. Photovoltaic inverters and certain vehicle-to-home (V2H) interfaces commonly operate in this mode, producing power only when a stable grid reference is present. Such devices typically cease output when grid voltage is lost or falls outside acceptable thresholds.

In contrast, certain DERs may be capable of grid-forming operation, in which the device actively establishes voltage and frequency conditions independent of the grid. Examples include standby generators with built-in governors, advanced battery energy storage systems with islanding capabilities, or in some cases, EV systems configured for off-grid operation. These sources may continue to deliver power during grid outages and may even serve as a local voltage reference for other components within the system.

The HEMS may use this categorization to inform device control strategies during abnormal conditions. For instance, the HEMS may monitor operational parameters of each connected distributed energy source to assess whether the source is behaving as expected under given system conditions. During grid-connected operation, many DERs are anticipated to synchronize with the utility grid and follow grid parameters. Upon detecting a loss of grid voltage, the HEMS may determine that certain DERs, particularly those operating in a grid-following mode, should discontinue output automatically as a result of the loss of a valid voltage reference. If such DERs continue to export energy despite the absence of grid conditions that warrant ongoing operation, the HEMS may treat this as “abnormal behavior” or “misbehavior.”

To facilitate this determination, the HEMS may continuously monitor one or more system attributes including line voltage, power flow, DER output status, and grid availability. An abnormal behavior condition may be diagnosed when a DER continues to deliver power during a time window in which it would be expected to shut down—such as during a grid outage or following a grid disconnection event. The HEMS may incorporate programmable thresholds, time delays, or classification logic to differentiate between transient variations and sustained deviations that warrant intervention.

In some configurations, the HEMS may maintain an internal registry of DER attributes and expected behaviors under various scenarios. These profiles may define device-specific or class-specific responses to grid conditions, allowing the HEMS to cross-reference real-time behavior with expected performance. This approach enables the system to diagnose individual DERs that do not comply with operational expectations and selectively trigger targeted responses to maintain coordinated system behavior.

In response to detecting continued operation of a DER beyond a threshold duration or condition in which shutdown is expected, the HEMS may initiate an enforcement procedure to influence the DER to cease power output. In some implementations, this enforcement takes the form of a voltage increase applied to one or more AC lines to which the DER is electrically coupled. The voltage increase may be generated locally by the HEMS and may serve as a stimulus to prompt the DER's internal protection logic to trip or otherwise disengage the source from the energy system.

The voltage increase may be implemented through a power electronics interface within the HEMS, such as a HEMS inverter configured to operate in a grid-forming capacity and to adjust or control voltage levels during grid outages. This inverter may selectively increase the voltage on an output line or phase beyond a defined nominal value or threshold associated with DER ride-through capabilities. By exceeding this threshold, the HEMS may induce the DER to disconnect under its own protective control scheme, rather than relying on explicit communication or manual intervention.

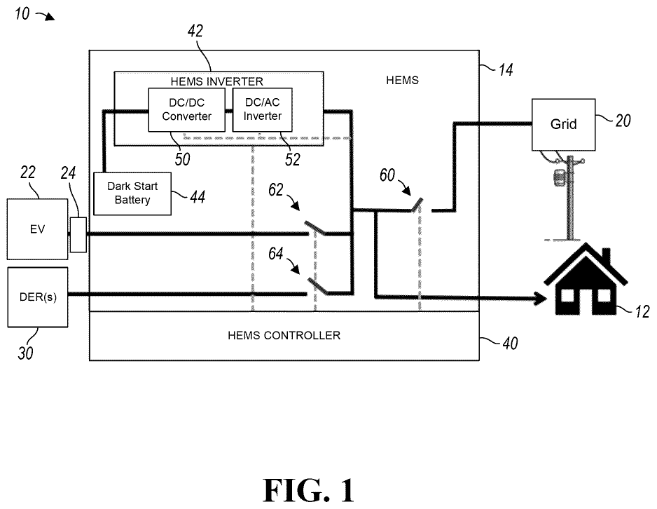

Referring now to FIG. 1, a home energy system 10 includes a residence or building structure 12 served by a Home Energy Management System (HEMS) 14. The HEMS 14—also referred to as a “HEMS hub” or “combiner box”—acts as an integration and coordination point for external and local energy resources. In the example shown, the HEMS 14 is electrically connected to an external power grid 20, to an electric vehicle (EV) 22 via associated electric vehicle supply equipment (EVSE) 24, and to one or more distributed energy resources (DERs) 30. Each of these connections may include an associated relay switch—relay 60 couples the HEMS 14 to the grid 20, relay 62 couples the HEMS 14 to the EV 22 through EVSE 24, and relay 64 couples the HEMS 14 to the distributed energy source 30. These relays may be selectively actuated under the control of the HEMS 14 to isolate or connect respective energy components depending on system conditions.

The electrical interconnections shown in FIG. 1 are configured to enable energy exchange among the grid 20, the EV 22, the DER 30, and the home 12 under a range of operating conditions. During grid-connected operation, the relays 60, 62, and 64 may be selectively closed to permit coordinated energy flow between the utility grid, the home, and any local energy contributors. In the event of a grid outage or intentional grid disconnection, the HEMS 14 may transition to an off-grid or backup mode of operation. In this condition, one or more of the relays may be opened to electrically isolate the grid connection, while allowing continued interaction between the remaining local components. The illustrated architecture permits dynamic reconfiguration of energy pathways based on real-time availability, system health, and predefined control logic managed by the HEMS 14.

The external utility grid 20 serves as a primary energy source for the home energy system 10 during normal operating conditions. Electrical power from the grid 20 may be delivered to the HEMS 14 through relay 60, which forms a controllable switching interface between the grid and the rest of the system. Under standard operation, relay 60 may remain in a closed state, allowing grid power to flow into the HEMS 14 and, from there, be distributed to household loads, charge energy storage systems, or supply power to the EV 22 via the EVSE 24. The HEMS controller 40 may continuously monitor electrical parameters associated with the grid connection—such as voltage, frequency, or current flow—using onboard measurement circuitry or auxiliary sensors.

When a grid-loss condition is detected, the HEMS controller 40 may initiate a transition to off-grid operation. This transition may include opening relay 60 to electrically isolate the home energy system 10 from the external grid 20. Such disconnection may allow continued use of grid-forming components. The opening of relay 60 also serves as a logical trigger for other HEMS logic modules—such as evaluation of DER behavior, initiation of backup power sources, or voltage-based coordination actions discussed in greater detail herein. When grid power is restored and verified to be stable, the HEMS controller 40 may re-close relay 60 and resume grid-synchronized operation in a coordinated manner.

The home energy system 10 includes an EV 22 connected to the HEMS 14 via EVSE 24. The EVSE 24 forms the interface through which the EV 22 exchanges electrical energy with the rest of the system. Relay 62, positioned between the EVSE 24 and the HEMS 14, provides a controllable electrical connection under the supervision of the HEMS controller 40. In some implementations, the EV 22 may be configured for bidirectional power transfer, allowing its traction battery to be charged from the home or, alternatively, to discharge power back into the system in a vehicle-to-home (V2H) mode.

The HEMS controller 40 may selectively open or close relay 62 to enable or prevent the EV 22 from contributing to or drawing energy from the home energy system 10. During grid-connected operation, the HEMS controller 40 may close relay 62 to allow the EVSE 24 to receive grid power for vehicle charging. In other cases—such as when grid power is unavailable or the system has transitioned to a backup operating mode—the HEMS may assess whether the EV 22 can serve as an available local power source. If the EV 22 supports V2H capability and sufficient charge is present, the HEMS may close relay 62 and configure the EVSE 24 to deliver energy into the home or to support voltage-based DER control functions. In implementations without bidirectional capability, the HEMS may open relay 62 to inhibit vehicle load from interfering with other system priorities or to preserve stored energy within the vehicle.

The home energy system 10 further includes one or more distributed energy resources (DERs) 30 connected to the HEMS 14 via relay 64. As noted previously, DER 30 may represent a wide range of locally installed power sources or storage devices, including—but not limited to—solar photovoltaic (PV) systems, combustion generators, stationary batteries, or vehicle energy systems configured for V2H support. In the illustrated example, relay 64 governs the electrical coupling between the DER 30 and the remainder of the home energy system 10, enabling the HEMS controller 40 to dynamically include or exclude the DER from active participation based on operating conditions.

Relay 64 may be used to isolate DER 30 during startup, shutdown, or fault conditions. Under normal grid-connected conditions, the HEMS controller 40 may monitor the output of DER 30 and determine whether to activate relay 64 in coordination with other energy components. In some implementations, DER 30 may operate in a grid-following mode, synchronizing to grid voltage and frequency when connected. If a grid loss event is detected, the HEMS controller 40 may observe whether DER 30 responds appropriately—such as by ceasing output. If the DER 30 continues operating when it should not, the HEMS controller 40 may initiate countermeasures as discussed further herein, including engaging inverter-based voltage manipulation to prompt shutdown.

When the system operates in a grid-outage mode, relay 64 allows the HEMS controller 40 to reconnect DER 30 when such operation is appropriate. In systems where DER 30 includes grid-forming capabilities (e.g., a generator or configured storage system), the HEMS controller 40 may use relay 64 to integrate the DER into a microgrid-type configuration for continued operation. In contrast, if the DER is identified as misbehaving under off-grid conditions (e.g., continuing to export power when not intended), the relay may remain open to prevent unintended power flows or to protect downstream equipment.

The HEMS 14 includes a HEMS controller 40 that monitors, coordinates, and controls the various components of the home energy system 10. The HEMS controller 40 may serve as the supervisory logic unit that governs the behavior of system elements based on real-time measurements, system states, and predefined operational rules. In the example shown, the HEMS controller 40 is operatively coupled to each of relays 60, 62, and 64 and may transmit control signals to open or close these relays 60, 62, 64 in response to detected conditions. In this way, the HEMS controller 40 may selectively isolate or connect external sources, such as the grid 20, the electric vehicle 22, or the DER 30, depending, for example, on whether these components are available, needed, or misbehaving. The HEMS controller 40 may also monitor system-level parameters such as AC line voltage, current flow, and frequency to evaluate grid availability, load demand, and source performance. In some implementations, the controller 40 may include or interface with memory and processing components storing execution routines, as well as measurement inputs and communication ports for local or remote supervision. This supervisory control enables the HEMS controller 40 to enforce system protection logic, coordinate source prioritization, and trigger responses such as the voltage-based DER shutdown techniques described in greater detail herein.

The HEMS 14 further includes a HEMS inverter 42 operatively coupled to the HEMS controller 40. The HEMS inverter 42 is configured to generate AC output for distribution within the home energy system 10, particularly during grid-outage conditions. In the illustrated embodiment, the HEMS inverter 42 includes both a DC/DC converter 50 and a DC/AC inverter 52 arranged in series. The DC/DC converter 50 is electrically coupled to a local power source (e.g., a dark start battery 44, as discussed below) and may function to adjust or maintain the DC voltage level provided to the DC/AC inverter 52. The DC/AC inverter 52 may in turn convert this conditioned DC input into an alternating current (AC) output compatible with residential distribution standards.

Under normal grid-connected operation, the HEMS inverter 42 may remain inactive or operate in a bypass mode depending on system configuration. However, when a grid outage is detected, the HEMS inverter 42 may become active and serve as the primary AC power source for the system. In this off-grid mode, the HEMS inverter 42 may synthesize an AC voltage waveform having a nominal grid frequency (e.g., 60 Hz in North America) and magnitude sufficient to maintain operation of local loads or to provide a reference voltage to other system components. In some implementations, the AC output of the HEMS inverter 42 may be directed along one or more lines to which DERs are also connected. As described further below, this capability may be leveraged to implement a voltage-based enforcement technique to suppress or terminate output from an abnormally-behaving DER during grid loss. The HEMS inverter 42 may thus operate not only as a backup power source, but also as a local voltage reference generator and system enforcer during abnormal operating conditions.

The HEMS 14 may include a dark start battery 44 electrically coupled to the DC/DC converter 50 of the HEMS inverter 42. The dark start battery 44 serves as a dedicated energy source for initiating inverter operation during grid outages, including so-called “black start” or “dark start” scenarios in which no external power is available. In some implementations, the dark start battery 44 is maintained in a charged state while the system is grid-connected and remains isolated from primary loads or other system components during normal operation.

Upon detection of grid loss, the HEMS controller 40 may command activation of the HEMS inverter 42 using energy from the dark start battery 44. This enables the HEMS inverter 42 to generate a local AC voltage even in the absence of power from the grid 20 or other DERs 30. Once activated, the HEMS inverter 42 may continue to draw energy from the dark start battery 44 for a limited period or may subsequently rely on other available sources, such as a normally-operating DER 30, to support continued operation. In some cases, the dark start battery 44 may be sized only for initial activation and voltage synthesis, with ongoing power contributions handled by alternative sources after the HEMS inverter 42 has established an AC output.

In some implementations, the HEMS inverter 42 may operate in a grid-forming capacity. During grid-connected operation, the inverter 42 may remain passive or operate in a supporting role, such as balancing power flows or managing local voltage conditions. However, when the external grid 20 becomes unavailable, the HEMS inverter 42 may actively generate an alternating current (AC) voltage waveform, thereby establishing a local reference to which other devices in the system may synchronize. This functionality allows the HEMS hub 14 to maintain operational continuity and to coordinate behavior among attached power sources and loads, even in the absence of grid voltage. In certain implementations, the HEMS inverter 42 may transition into this grid-forming role automatically upon detecting grid loss, may be activated by logic executed by the HEMS controller 40, or may be selectively enabled depending on system conditions. In some configurations, this capability may also facilitate operation of the system as a microgrid, enabling continued operation of grid-following DERs 30 and maintaining stability during extended outages.

The dark start battery 44 may therefore facilitate autonomous grid-forming behavior by the HEMS inverter 42. In certain embodiments, the battery 44 allows the system to respond proactively to abnormal DER behavior—such as continued output by a grid-following DER 30 after grid loss—by powering inverter-based voltage rise functionality.

In some implementations, the HEMS hub 14 may be embodied in a unitary enclosure—often referred to as a “combiner box”—that physically houses the major control and power-handling components of the home energy management system. This enclosure may include mechanical structures for mounting and securing internal components, as well as provisions for electrical interconnection, heat dissipation, and environmental protection. For example, the enclosure may include one or more compartments, internal mounting rails, or backplanes configured to support the HEMS controller 40, the HEMS inverter 42, and the dark start battery 44 in a compact and coordinated arrangement. Enclosure features may also include high-voltage busbars, DC and AC wiring terminals, relays, sensors, fuses, and communication ports for integrating the system into the broader home electrical infrastructure.

In other configurations, the components of the HEMS hub 14—such as the controller 40, the HEMS inverter 42, and the dark start battery 44—may be physically distributed rather than housed within a single enclosure. For instance, the dark start battery 44 may be located externally to reduce enclosure size, support user-replaceability, or meet specific thermal or spatial design considerations. Likewise, the HEMS controller 40 and HEMS inverter 42 may be housed in separate enclosures or located in different areas of the premises. In these distributed implementations, the components may be electrically coupled via appropriate wiring harnesses, communication links, or power bus interfaces to maintain integrated system functionality. Regardless of the physical arrangement, the logical configuration of the HEMS hub 14 may remain consistent, with the controller 40 coordinating system behavior and the inverter 42 and battery 44 supporting power conversion and continuity functions as described herein.

While the illustrated embodiment of FIG. 1 depicts a single DER 30, the HEMS controller 40 may be configured to monitor and coordinate the operation of multiple DERs 30 within the home energy system 10. Each DER 30 may be independently connected to the HEMS hub 14 through a dedicated interface—such as an individual relay and sensing circuit—or may be connected through a shared bus. The logic described herein, including misbehavior detection and voltage-based enforcement strategies, may be applied selectively or collectively depending on system configuration. For example, the HEMS controller 40 may assess whether one or more DERs 30 do not respond to a shutdown trigger and initiate corrective action (e.g., voltage adjustment) targeted to the affected line. In systems with multiple DERs 30, such action may be localized to specific feeders or zones, or applied system-wide.

In some implementations, the electric vehicle 22 and associated EVSE 24 may serve not only as a load during charging operations, but also as a distributed energy source capable of supplying power to the home. For example, a bidirectional EVSE 24 may enable vehicle-to-home (V2H) functionality, in which a traction battery of the EV 22 delivers energy into the home energy system 10 under control of the HEMS hub 14. This energy may be routed to support household loads or to drive voltage manipulation logic such as that described above. In such configurations, the EV 22 and EVSE 24 together may operate in either a grid-following mode—requiring shutdown upon grid loss—or a grid-forming mode, in which local voltage and frequency may be supported even in the absence of utility power. In some scenarios, the EV-based energy source may be used as a substitute or supplement to the dark start battery 44, providing the necessary DC power input for HEMS inverter 42 operation during grid outage conditions.

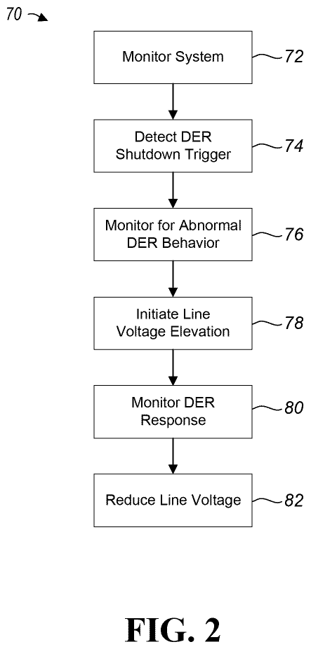

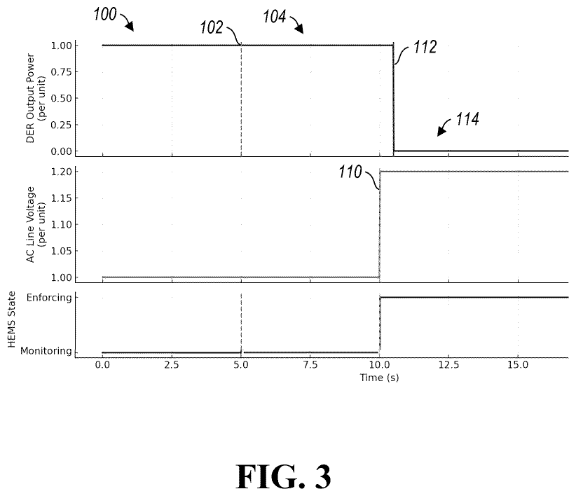

Referring now to FIGS. 2 and 3, a sequence of operations may be implemented by the HEMS 14 to detect and respond to abnormal behavior by a connected energy source. At step 72 of the method 70 of FIG. 2, the system monitors the home energy environment during normal, grid-connected operation. In this state, the utility grid is available, and relay 60 may be closed to permit power exchange between the home 12 and the external grid 20. The HEMS controller 40 may collect real-time information regarding the state of the grid, voltage levels at the output of the HEMS 14, energy consumption by household loads, and the activity of any local energy sources including the DER 30 or the electric vehicle 22 via EVSE 24. The DER 30 may be synchronized to the utility grid and configured to operate in a grid-following mode, contributing power to the home energy system under normal voltage and frequency conditions. In this scenario, the HEMS may prioritize grid power while selectively engaging or monitoring local sources based on control settings or other criteria. The HEMS controller 40 does not detect any grid faults or abnormal DER behavior during this interval and maintains default operating parameters.

During an initial period, identified by arrow 100 in FIG. 3, the system operates under the normal conditions. In this state, a connected DER 30 is actively contributing energy, with DER output shown in the top chart at a nominal level of 1 pu (per unit). The term “per unit” refers to a normalized value relative to a defined base quantity—in this context, 1 pu may correspond to the rated output voltage or power of the DER 30. Concurrently, the middle chart shows that the AC line voltage to which the DER 30 is connected is also at 1 pu. This flat voltage level may indicate that the system is synchronized with the grid or otherwise operating stably without requiring voltage intervention by the HEMS 14. The system remains in this state until a DER shutdown event occurs.

At step 74 of the method shown in FIG. 2, the HEMS 14 detects a DER shutdown trigger condition or event. This event—identified at reference numeral 102 in FIG. 3—may occur as a result of a variety of system conditions that would ordinarily require one or more DERs 30 to cease operation. In some examples, the shutdown trigger may correspond to a grid outage or disconnection, which in typical systems would be expected to cause grid-following DERs 30 to autonomously cease power output. In other cases, the trigger may be an explicit command or signal issued by the HEMS 14 or another supervisory system component, directing the DER 30 to shut down in response to grid-support requirements, protective behavior, or local coordination objectives.

The HEMS controller 40 may detect the occurrence of the shutdown trigger through various sensing or status monitoring mechanisms. For example, loss of voltage on the grid-side connection—as determined through voltage sensing at or near the grid relay—may indicate that the grid is no longer present and that DERs 30 configured to follow grid voltage and frequency should discontinue output. Similarly, loss of grid synchronization, receipt of a shutdown command sent via a communication interface, or detection of voltage or frequency excursions beyond normal operating thresholds may also qualify as shutdown triggers. The system may optionally support multiple concurrent trigger conditions, and the detection logic may be configured to recognize one or more qualifying events before initiating follow-up actions.

In addition to grid-related events, the HEMS 14 may also initiate DER shutdown evaluation in response to operational abnormalities that arise during system monitoring. These abnormalities may reflect unexpected or uncommanded behaviors, interruptions in system coordination, or degraded performance that could affect the stability of the home energy environment. Unlike grid-loss conditions—which are externally driven and often abrupt—these operational conditions may emerge during normal system operation. When such conditions are detected, the HEMS controller 40 may treat them as DER shutdown triggers and initiate a response pathway similar to that used for grid outages. In some implementations, voltage-based enforcement logic may be reserved specifically for conditions that persist despite initial attempts to coordinate DER behavior through communication interfaces or relay control logic.

One class of operational abnormalities includes hardware coordination issues that compromise the HEMS controller's ability to manage energy pathways. For instance, if a relay 60, 62, or 64 within the HEMS hub 14 becomes stuck in the closed position, the system may lose the ability to isolate an attached DER 30. This inability to electrically disconnect the DER 30 may introduce uncontrolled power flow, especially during conditions that require rapid reconfiguration of the system. Similarly, if a relay becomes unresponsive to actuation commands, the HEMS controller 40 may no longer be able to execute its intended control strategy. In these cases, the continued presence of DER output on a monitored line may be interpreted as an abnormal condition warranting shutdown enforcement.

Another category of conditions involves the quality and stability of DER-sourced power. The HEMS 14 may monitor electrical parameters such as total harmonic distortion (THD), voltage magnitude, and frequency deviation to identify such conditions. When measured attributes exceed configurable thresholds, the HEMS controller 40 may determine that the affected DER 30 should be isolated or shut down.

A third group of conditions involves disruptions in the HEMS system's ability to communicate with or synchronize to the DER 30. If the DER 30 does not respond to polling messages, ceases transmitting status updates, or otherwise becomes unresponsive over a communications interface, the system may be unable to verify its current operating state. Additionally, some DERs 30 are expected to modulate their behavior in response to local voltage and frequency variations. If a DER 30 is unable to adjust its output to align with detected system frequency, or continues to inject current during over-or under-voltage events, its behavior may be considered to be deviating from coordination logic. In such cases, the HEMS 14 may initiate shutdown logic to restore a predictable and managed energy state.

In some embodiments, the HEMS controller 40 may correlate timestamps of expected DER shutdown with the issuance or occurrence of the trigger event. This allows the system to track elapsed time from the shutdown trigger and establish a window during which shutdown behavior is expected. Once the shutdown trigger has been detected and verified, the system proceeds to evaluate the DER's response—specifically, whether the DER 30 has properly ceased output as expected, or has instead maintained an output.

At step 76, the HEMS controller 40 enters a monitoring interval following the detection of a DER shutdown trigger. This interval—identified at reference numeral 104 in FIG. 3—defines a window during which the DER 30 is expected to respond to the shutdown trigger event 102. During this interval, the HEMS 14 monitors DER behavior to determine whether the DER 30 has ceased output as intended, or has instead maintained an output. If the DER 30 continues to produce power beyond a threshold duration following the shutdown trigger, the DER 30 may be considered to be misbehaving. In the example illustrated in the top chart of FIG. 3, the DER 30 maintains a power output of approximately 1 per unit (pu) during the time interval following the shutdown trigger 102, even beyond 5 seconds after the shutdown trigger 102. This persistence of output indicates that the DER 30 has not followed the expected shutdown behavior, suggesting that it has either did not detect the trigger, has malfunctioned, or is otherwise operating outside intended control bounds.

The HEMS 14 may assess DER behavior using real-time sensing or monitoring of power flow through the HEMS hub, relay-connected subcircuits, or metering devices coupled to the DER 30. In other implementations, this evaluation may be supplemented by data received over communications links, such as DER status reports or confirmation messages. If no valid shutdown response is detected within the allocated time interval (e.g., 5 seconds in the illustrated example), the system flags the DER as unresponsive and transitions to step 78, initiating voltage-based enforcement logic.

While the example shown in FIG. 3 involves a single DER 30, in other implementations, the HEMS 14 may monitor multiple DERs 30 independently or in coordination. The misbehavior detection logic may be tailored based on the type of DER 30 being monitored. For example, grid-following DERs—such as photovoltaic inverters—are typically expected to shut down automatically upon grid loss, whereas grid-forming DERs—such as standby generators or battery systems—may not be subject to the same shutdown expectations. Accordingly, the misbehavior detection logic may be applied selectively to DERs 30 based on their type, configuration, or role within the system.

At step 78, in response to confirmed DER misbehavior during the monitoring interval, the HEMS 14 initiates an active enforcement procedure. This procedure involves temporarily increasing the voltage on one or more AC lines to which the DER 30 is electrically coupled. The voltage rise event is depicted in the middle chart of FIG. 3, beginning at visual marker 110, which marks the onset of the system-generated voltage escalation.

The HEMS controller 40 may initiate this voltage rise by issuing a control command to a power conversion element—such as the HEMS inverter 42—configured to inject or adjust AC voltage on the target line. In the illustrated implementation, this adjustment causes the AC line voltage to increase from 1.0 per unit (pu) to an increased value, for example less than or equal to 1.5 pu, and more particularly, approximately 1.2 pu. The per-unit (pu) system provides a normalized basis for comparing voltage magnitudes relative to nominal operating levels; a value of 1.0 pu represents nominal voltage (e.g., 120V RMS), while 1.2 pu corresponds to a 20% overvoltage (e.g., approximately 144V RMS in this case).

The nature of the voltage rise may vary depending on implementation. In some systems, the increase may be executed as a step change, where the voltage quickly transitions to the elevated level. In other implementations, a ramp-style transition may be used, gradually increasing the voltage over a defined interval. The shape, duration, and magnitude of the voltage rise may be determined by programmable parameters within the HEMS 14, potentially based on DER manufacturer shutdown thresholds, or empirical system behavior.

By generating this elevated voltage condition, the system provokes a shutdown response from the misbehaving DER 30. Many DERs, particularly grid-following inverters, are programmed to disconnect from the system when voltage exceeds a defined operational limit. The HEMS 14 leverages this aspect to enforce shutdown in a situation where passive expectations have not succeeded. In addition to voltage rise, alternative or complementary enforcement mechanisms may be employed, such as temporary frequency deviation, current injection, or communication-based shutdown commands.

At step 80, the HEMS controller 40 evaluates whether the voltage manipulation initiated in the preceding step has successfully resulted in DER shutdown. The top chart of FIG. 3 illustrates the energy output of the monitored DER 30, showing that the DER 30 continues delivering power during the abnormal interval (e.g., between shutdown trigger 102 and voltage rise 110) but eventually discontinues output at a time marked by visual indicator 112. This cessation corresponds to the DER 30 responding to the overvoltage condition induced by the HEMS 14.

There may be a brief latency between the initiation of the voltage rise and the DER's actual shutdown, depending on the DER's firmware, trip delay settings, or internal logic. This delay is reflected in FIG. 3 by the gap between the voltage rise at 110 (middle chart) and output drop at 112 (top chart). During this period, the HEMS 14 may continue maintaining the elevated voltage to enforce the shutdown condition.

The shutdown confirmation may be made through any of a variety of direct or indirect sensing techniques. In some implementations, the HEMS controller 40 measures current flow or power output on the DER's associated feeder line using current sensors or metering components. A drop to zero (or near-zero) output following the enforcement action, as indicated at interval 114, may be interpreted as successful DER deactivation. In other embodiments, logic within the HEMS 14 may evaluate changes in voltage stability, power quality, or the behavior of other coupled components as secondary confirmation.

In cases where DER shutdown is not confirmed within a defined timeout window, the HEMS controller 40 may determine that standard coordination efforts have not succeeded and proceed to alternative enforcement measures. These measures may include the initiation of voltage-based shutdown logic, activation of secondary isolation devices, or transition into a specialized fault-handling routine. The timeout window may be configured based on system requirements or DER type, and may represent the maximum allowable period during which DER output is permitted to continue following a shutdown trigger. If no valid shutdown is observed before the expiration of this window, the system may log the event, raise an alert, and implement one or more enforcement strategies to bring the system back into a controlled and predictable state.

Once the HEMS controller 40 confirms that the DER 30 has ceased output (e.g., by detecting the shutdown event 112 in FIG. 3, top chart), the HEMS 14 may initiate post-action procedures. These may include reducing the elevated voltage back toward nominal levels, generating a system log entry, issuing a user or utility notification, or proceeding with reconfiguration of the system to operate with remaining DERs or storage assets. More particularly, at step 82, the voltage on the monitored line may be gradually or abruptly decreased from the elevated level (e.g., 1.2 pu) back to the nominal value (e.g., 1.0 pu).

The logic governing the duration and transition of this voltage restoration may vary across implementations. In some configurations, the HEMS controller 40 may apply a fixed-duration voltage rise—such as 1 to 5 seconds—after which voltage is automatically lowered. In other scenarios, the system may continue maintaining the elevated voltage until the DER shutdown is confirmed, or for the shorter of a fixed time interval or DER confirmation. The voltage drop itself may occur as a step change, a linear ramp, or a smoothed decay curve depending on power considerations or inverter control dynamics.

This controlled voltage reduction limits long-term overvoltage exposure for other connected equipment and allows the system to return to a steady-state operational mode. In systems with multiple DERs 30 or controllable loads, the HEMS controller 40 may evaluate which components remain online and update operational priorities accordingly.

In some implementations, this post-action phase may also involve system logging, fault flag clearing, or user notification steps. The HEMS 14 may issue a status report or fault resolution message to a local interface, mobile application, or cloud-based platform, indicating that an abnormal DER 30 was detected, voltage enforcement was applied, and shutdown was successful. These notifications may be timestamped and may include relevant voltage levels, action durations, and shutdown confirmation indicators for diagnostic purposes.

The foregoing description outlines a control strategy for managing energy sources within a home energy system using a HEMS-configured voltage manipulation technique. During grid-connected operation, local DERs may operate in parallel with the utility, while grid-forming components may remain idle. When a grid-loss event occurs, a DER shutdown condition arises, or a DER shutdown command is issued, the HEMS controller 40 may monitor DER behavior to determine whether shutdown occurs as expected. If the DER 30 continues to export power beyond an allowed threshold or observation period, the HEMS 14 may initiate a voltage rise—such as increasing a monitored line voltage from 1.0 pu to 1.2 pu—through the HEMS inverter 42 or other local power electronics. This elevated voltage condition may induce the DER 30 to cease output, either through built-in protection mechanisms or control response. The voltage rise may be maintained temporarily and deactivated after confirmation of DER shutdown or after expiration of a predefined time interval. This enforcement logic may be tailored to grid-following or grid-forming devices, enabling selective control across a wide range of energy source types while supporting grid-interactive and backup operating modes.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A home energy management system (HEMS), comprising:
a controller configured to monitor a line coupled to a distributed energy resource (DER); and
an inverter electrically connected to the line and operable to generate an alternating current (AC) voltage on the line, wherein the controller is further configured to, after a DER shutdown trigger and the DER producing an output after an interval, command the inverter to increase the AC voltage on the line to a level that induces a shutdown response from the DER.

2. The HEMS of claim 1, wherein the DER shutdown trigger comprises a relay condition associated with the DER.

3. The HEMS of claim 1, wherein the DER shutdown trigger includes a loss of grid voltage detected at a relay electrically coupling the DER to a utility power source.

4. The HEMS of claim 1, wherein the DER shutdown trigger comprises an operational abnormality associated with the DER including at least one of loss of communication between the controller and the DER, unstable power output from the DER, or DER-induced power quality issues.

5. The HEMS of claim 1, wherein the level comprises a fixed per unit (pu) voltage greater than 1.0 pu and less than 1.5 pu.

6. The HEMS of claim 1, wherein the inverter comprises a DC/AC inverter operatively coupled to a DC voltage source and configured to generate the AC voltage using stored energy.

7. The HEMS of claim 1, wherein the inverter is a component of a grid-forming system configured to inject voltage onto the line during grid outage conditions.

8. A home energy system, comprising:
a distributed energy resource (DER) configured to output electrical power for an alternating current (AC) line and to cease outputting the electrical power when a voltage on the AC line exceeds a value;
an inverter electrically connected to the AC line and operable to generate an AC voltage on the AC line; and
a controller operatively coupled to the inverter and configured to command the inverter to increase the AC voltage on the AC line such that the distributed energy resource ceases the outputting.

9. The home energy system of claim 8, wherein the DER comprises a vehicle battery coupled to the AC line through a bidirectional electric vehicle supply equipment (EVSE) interface.

10. The home energy system of claim 8, wherein the DER includes an interface configured to receive a shutdown command, and the DER is further configured to cease the outputting in response to receiving the shutdown command.

11. The home energy system of claim 8, further comprising a controllable relay switch electrically coupled between the inverter and the DER, wherein the controllable relay switch is operable under control of the controller to selectively isolate or connect the DER.

12. A method of operating a home energy system, comprising:
in response to a distributed energy resource (DER) not discontinuing a power output to an AC line within an interval beginning with a condition under which the DER is expected to discontinue the power output, increasing, by an inverter electrically coupled to the AC line, a voltage on the AC line.

13. The method of claim 12, wherein the condition comprises an absence of voltage on a grid-side connection.

14. The method of claim 12, wherein the condition comprises a shutdown command.

15. The method of claim 12, wherein the condition comprises an abnormal operating condition associated with the DER.

16. The method of claim 12, further comprising:
initiating a timer upon detection of the condition.

17. The method of claim 12, wherein the increasing comprises the inverter elevating the voltage from a level of 1.0 per unit (pu) to approximately 1.2 pu.

18. The method of claim 12, further comprising:
discontinuing, by the DER, the power output to the AC line in response to the voltage on the AC line exceeding a value.

19. The method of claim 12, further comprising:
in response to the DER discontinuing the power output, ceasing the increasing.
